(19) United States
(12) Patent Application Publication
(10) Pub. No.: US 2026/0088233 A1
(43) Pub. Date: Mar. 26, 2026

(54) STABILIZER MODULE FOR A KEYBOARD KEY STRUCTURE

(71) Applicant: Logitech Europe S.A., Lausanne (CH)

(72) Inventors: Po-Han Hsiao, Kaohsiung (TW); Tian-Jun Luo, Suzhou (CN); Kuan-Chieh Liang, Taipei City (TW)

(21) Appl. No.: 18/892,012

(22) Filed: Sep. 20, 2024

(51) Int. Cl. H01H 3/12; H01H 13/14

(52) U.S. Cl. CPC H01H 3/122; H01H 13/14; H01H 2221/058

(57) ABSTRACT

An improved stabilizer module for a keyboard key has an elongated balance bar. First and second bases are mounted to engage first and second ends of the elongated balance bar, each with a curved, mostly vertical slot. First and second stems are mounted in first and second cavities in the first and second bases, respectively, for vertical movement within the first and second cavities. The stems each have a horizontally extending slot. Both the base and stem slots engage an end of the elongated balance bar.

### BACKGROUND

In large mechanical keys, such as a space bar, a balance bar structure can be used to provide structural support to the key to prevent it from tilting (e.g., like a seesaw) when the key is pressed on one end of the key cap or the other. The structural support can include two slider structures that support the balance bar in internal tracks that allow the balance bar to rotate within the tracks and move up and down as the key is depressed. An example of an architectural arrangement of such a key structure is shown in Logitech U.S. Pat. No. 11,163,375 and in FIGS. 1 and 2 herein. As the key is depressed, the movement of the balance bar within the tracks and the impact of the various structures against surfaces can significantly contribute to key noise.

Logitech U.S. Pat. No. 11,163,375 addresses the noise problem by adding a compliant material (e.g., rubber) at the contact points of the metal balance bar against the plastic key structures. Another solution to the key noise is to add grease at key points in the structure.

It should be noted that unless otherwise indicated herein, the materials described in this section are not prior art to the claims in this application and are not admitted to be prior art by inclusion in this section.

### SUMMARY

In certain embodiments, a stabilizer module for a keyboard key is provided. The stabilizer module has an elongated balance bar. First and second bases are mounted to engage first and second ends of the elongated balance bar, each with a curved, mostly vertical slot. First and second stems are mounted in first and second cavities in the first and second bases, respectively, for vertical movement within the first and second cavities. The stems each have a horizontally extending slot. Both the base and stem slots engage an end of the elongated balance bar.

In some embodiments, the first and second ends of the elongated balance bar are the ends of U-shaped end-pieces at the end of the elongated balance bar. The elongated balance bar is metal to provide strength for the desired torsional balance and the U-shaped end-pieces are plastic to minimize noise against the plastic base and stem.

In embodiments, before a key press, each stem is high in the cavity of its base. An end-piece of the balance bar has rotated around the balance bar so that an insertion arm of the end-piece is near the top of the curved slot in the base and near one side of the horizontal slot in the stem. During a key press, the stem is pushed downward, causing the end-piece to rotate around the axis of the balance bar, and move downward. The downward movement tracks the curved base slot as the end-piece rotates, and the insertion arm of the end-piece moves side-to-side in the horizontal slot of the stem. This structure allows easy assembly and tight tolerances on the slots, giving a structure with little play and thus little noise. In addition, the plastic end-pieces provide plastic on plastic contact, which is less noisy than the metal on plastic contact of the prior art.

In further embodiments, a method for assembling a stabilizer module for a keyboard key is provided. Plastic end-pieces are attached over the ends of a metal balance bar. The balance bar is inserted into retaining slots in a pair of base structures. Stems, having horizontally extending slots, are inserted into cavities of the base structures. The base structures, with the inserted stems, are slid laterally to the edges of the balance bar until insertion arms of the plastic end-pieces of the balance bar are inserted into curved, mostly vertical slots of the base and horizontally extending slots of the stems.

In some embodiments, a stabilizer module for a keyboard key comprises an elongated balance bar, first and second bases mounted to engage first and second ends of the elongated balance bar with first and second curved, mostly vertical slots for engaging the first and second ends of the elongated balance bar, and first and second stems mounted in first and second cavities in the first and second bases, respectively, for vertical movement within the first and second cavities, and having horizontally extending slots. The first and second ends of the elongated balance bar can be insertion arms of U-shaped end-pieces at the end of the elongated balance bar. In some aspects, the elongated balance bar is metal and the U-shaped end-pieces are plastic. The elongated balance bar can be mounted in securing slots at a bottom of the first and second bases, such that the elongated balance bar rotates within the securing slots while the insertion arm moves vertically within the curved, mostly vertical slot as the stems are moved up and down. In some cases, the curved, mostly vertical slots are open at a bottom of the first and second bases, but is narrow at the bottom to keep the insertion arms of the elongated balance bar in the curved, mostly vertical slots. The stabilizer module can further include a plastic insert mounted below the keyboard key, flush with a metal top plate of the keyboard, with the first and second bases mounted on a printed circuit board below the plastic insert and metal top plate. In some aspects, the first stem has a plurality of bumps on a bottom of the first stem, wherein the second stem has a plurality of bumps on a bottom of the second stem, wherein the plurality of bumps on the bottom of the first stem and the second stem reduce their contact area and thus reduce their noise as the stems descend and contact a substrate at the bottom of the bases. In some cases, the stabilizer module includes a bump on the insertion arm for retaining the insertion arm within the slots of the base and stem. The stabilizer module can further include top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases. In some cases, the first and second curved, mostly vertical slots in the bases are curved at varying angles, with the varying angles being no less than 60 degrees and no more than 90 degrees.

In certain embodiments, a stabilizer module for a keyboard key comprises an elongated balance bar; first and second bases mounted to engage first and second ends of the elongated balance bar with first and second curved, mostly vertical slots for engaging the first and second ends of the elongated balance bar; and first and second stems mounted in first and second cavities in the first and second bases, respectively, for vertical movement within the first and second cavities, and having horizontally extending slots; and top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases. In some aspects, the first and second ends of the elongated balance bar are insertion arms of U-shaped end-pieces at the end of the elongated balance bar, wherein the elongated balance bar is metal and the U-shaped end-pieces are plastic, and wherein the elongated balance bar is mounted in securing slots at a bottom of the first and second bases, such that the elongated balance bar rotates within the securing slots while the insertion arm moves vertically within the curved, mostly vertical slot as the stems are moved up and down. In some aspects, the curved, mostly vertical slots are open at a bottom of the first and second bases, but is narrow at the bottom to keep the insertion arms of the elongated balance bar in the curved, mostly vertical slots. The stabilizer module can further include a pair of bumps on an interior of each of the U-shaped end-pieces at positions where the bumps contact a part of the first and second bases that reduces a contact area and thus reduces friction. The stabilizer module can include a bump on the insertion arm for retaining the insertion arm within the slots of the base and stem. In some aspects, the stabilizer module can include top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases. In certain implementations, the first and second curved, mostly vertical slots in the bases are curved at varying angles, with the varying angles being no less than 60 degrees and no more than 90 degrees.

In some embodiments, a method for assembling a stabilizer module for a keyboard key comprises: attaching plastic end-pieces over ends of a metal balance bar, the ends including a first end and a second end of the metal balance bar; inserting the metal balance bar into retaining slots in a pair of base structures; inserting stems, having horizontally extending slots, into cavities of the base structures; and sliding the base structures, with the inserted stems, laterally to the ends of the balance bar until insertion arms of the plastic end-pieces of the balance bar are inserted into curved, mostly vertical slots of the base and the horizontally extending slots of the stems. In some aspects, the first end and second end of the metal balance bar are insertion arms of U-shaped end-pieces at the end of the metal balance bar. The method can further include snapping each insertion arm into the slots past a bump on the insertion arm. In some cases, the curved, mostly vertical slots in the bases are curved at varying angles, with the varying angles being no less than 60 degrees and no more than 90 degrees.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 is a diagram of a prior art stabilizer module for a space bar key;

FIG. 2 is a diagram of a prior art stabilizer module showing the insertion of a balance bar into stem and base modules;

FIGS. 3-5 are diagrams of the assembly of the prior art stabilizer module of FIGS. 1-2, illustrating certain issues;

FIG. 6 is a diagram of an improved balance bar structure with U-shaped end-pieces, according to certain embodiments;

FIG. 7 is a diagram of the balance bar structure of FIG. 6 inserted into a novel base and stem structure, according to certain embodiments;

FIGS. 8-8B are diagrams of the stem structure, according to certain embodiments;

FIG. 9 is a diagram of a base structure, according to certain embodiments;

FIGS. 10 and 10A-B are diagrams of details of the balance bar's U-shaped end-pieces, according to certain embodiments;

FIGS. 11A-B are diagrams illustrating the rotation of the balance bar's U-shaped end-piece in the base and stem slots, according to certain embodiments;

FIGS. 12A-G are diagrams illustrating the method of assembly of the stabilizer module's balance bar, base and stem, according to an embodiment;

FIG. 13 is a flowchart for a method for assembling a stabilizer module for a keyboard key, according to certain embodiments;

FIG. 14 is a graph showing noise distribution of a key press for a conventional space bar key and a novel space bar key using aspects of the invention;

FIG. 15 is a diagram of a base structure for attaching to a PCB, according to certain embodiments;

FIG. 16 is a diagram of a noise-reducing plastic insert for a metal top plate of a keyboard, according to certain embodiments;

FIG. 17 is side, cutaway view of the insert of FIG. 16 in a keyboard structure, according to certain embodiments;

FIG. 18 is a perspective view of the plastic insert of FIG. 16 mounted below a space key, according to certain embodiments;

FIGS. 19 and 19A are top and perspective views of the plastic insert of FIG. 16, according to certain embodiments; and

FIG. 20 is a diagram of a bouncing PCB, according to certain embodiments.

Throughout the drawings, it should be noted that like reference numbers are typically used to depict the same or similar elements, features, and structures.

### DETAILED DESCRIPTION

Aspects of the present disclosure relate generally to input devices, and more particularly to computer peripheral devices with a mechanical keyboard, according to certain embodiments.

In the following description, various examples of keyboard systems and mechanical key structures are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

### Prior Art Devices

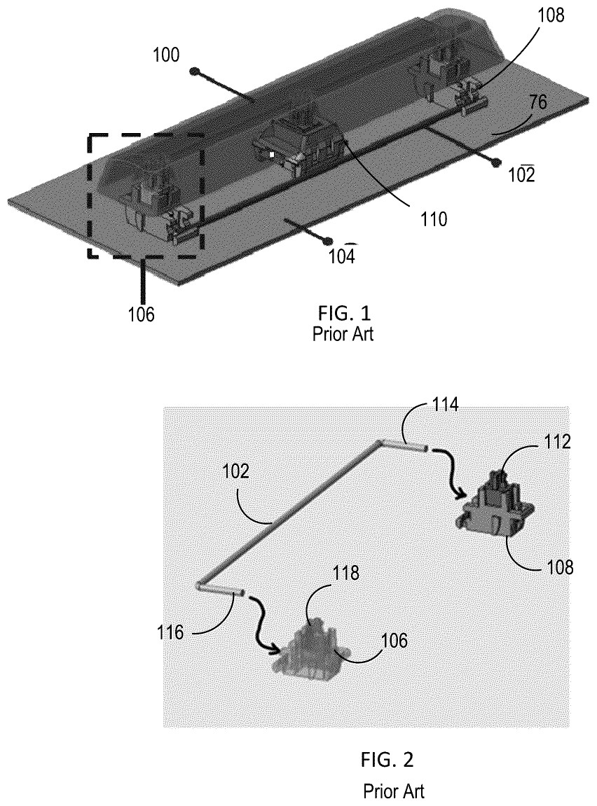

FIG. 1 is a diagram of a prior art stabilizer module for a space bar key. A space bar 100 is shown in phantom over a stabilizer module consisting of balance bar 102 and two base structures 106 and 108. A key switch 110 is in the middle, mounted on a printed circuit board (PCB) 104. When space bar 102 is depressed by a user, it will activate key switch 110. Base structures 106 and 108 lower the ends of balance bar 102 equally, so that the space bar doesn't tilt and can be pressed at any point and still activate key switch 110.

FIG. 2 is a diagram of a prior art stabilizer module showing the insertion of a balance bar into stem and base modules. Base structure 108 has an internal stem 112 which moves up and down within base structure 108. An end 114 of balance bar 102 inserts into a slot in stem 112. The other end 116 of the balance bar 102 inserts into a slot in in a similar stem 118 in base structure 106. The tops of stems 112 and 118 engage the inside of space bar 100 of FIG. 1. Thus, as the space bar is depressed, balance bar 100 transfers the downward force on the space bar to the two stems, causing both to descend equally within their respective base structures.

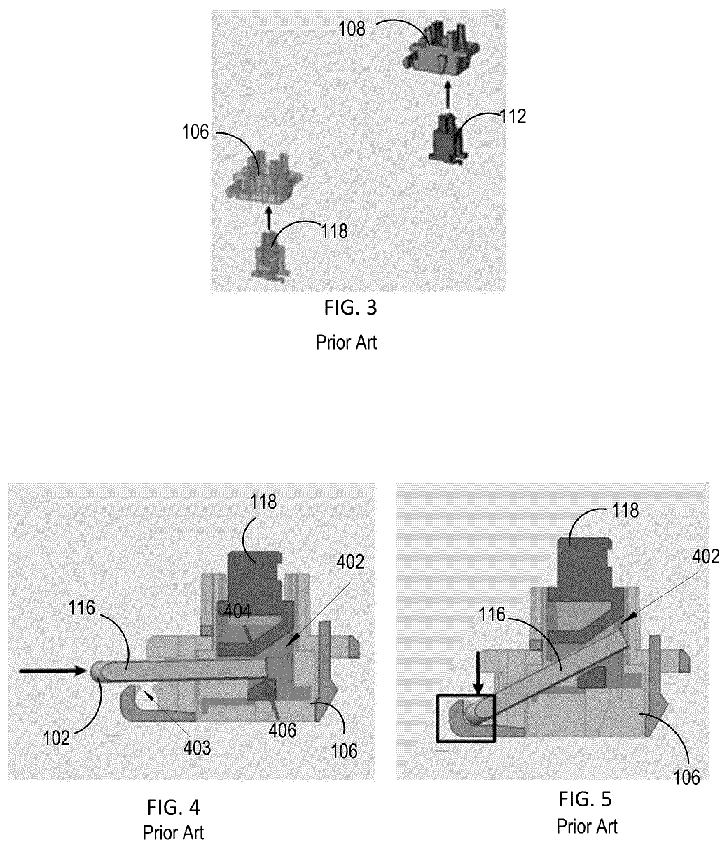

FIGS. 3-5 are diagrams of the assembly of the prior art stabilizer module of FIGS. 1-2, illustrating certain issues. FIG. 3 illustrates the insertion of stems 112 and 118 into base structures 108 and 106, respectively.

FIG. 4 illustrates the insertion of the end 116 of the balance bar into stem 118 while mounted in base structure 106. End 116 needs to go into a slot 402, with the main part of balance bar 102 snapping into a retaining slot 403. The entry gap into slot 402 needs to be wide enough to allow end 116 to enter with some margin for error, through a gap between arrows 404 and 406. If the gap is too small, the plastic stem 118 could be damaged upon insertion and it would be difficult to insert. Once inserted, the end 116 needs to angle upward, as shown in FIG. 5. Thus, the gap between arrows 404 and 406 needs to be sufficiently wide to allow this.

FIG. 5 illustrates the end 116 of the balance bar as it is inserted into stem 118 and with balance bar 102 snapped into retaining slot 403. The view of FIG. 5 shows the stem in the upward position, before pressing of the space bar by the user to depress the stem. The lowered position of the stem can be seen in FIG. 4.

A problem with this design is that the metal end 116 of the balance bar will clank against the stem slot and make noise. There is a fair amount of play designed in to allow the inserting and assembly, as discussed above, and thus the end of the balance bar is loose within the stem. The solutions to this clanking noise have been to either add soft rubber bumpers inside the slot 402, and/or to add grease at the contact points. Both of these solutions add to the complexity and cost of the assembly. Adding grease requires precision. Not enough grease causes worse acoustic performance, while too much grease causes sticky/stuck movement or grease leakage on the keyboard. The grease must be added with precision to the correct positions to achieve the noise reduction effect, without adding too much grease.

### High-level Summary

The following high-level summary is intended to provide a basic understanding of some of the novel innovations depicted in the figures and presented in the corresponding descriptions provided below. Aspects of the invention relate to mechanical keyboards and corresponding key structures that operate to reduce mechanical noise, such as the audible “clicks” typically heard when a user presses a key on a mechanical keyboard. Larger keys (e.g., space bar, tab, caps lock, shift, control, alt, enter, backspace, etc.) are subject to increased noise profiles due to their additional other mechanical components for key stability including slider structures and balance bar structures that are significant contributors to key noise. In large mechanical keys, such as a space bar, a balance bar structure can be used to provide structural support to the key to prevent it from tilting (e.g., like a seesaw) when the key is pressed on one end of the key cap or the other. The structural support can include two slider structures that support the balance bar in internal tracks that allow the balance bar to rotate within the tracks and move up and down as the key is depressed. As the key is depressed, the movement of the balance bar within the tracks and the impact of the various structures against surfaces can significantly contribute to key noise.

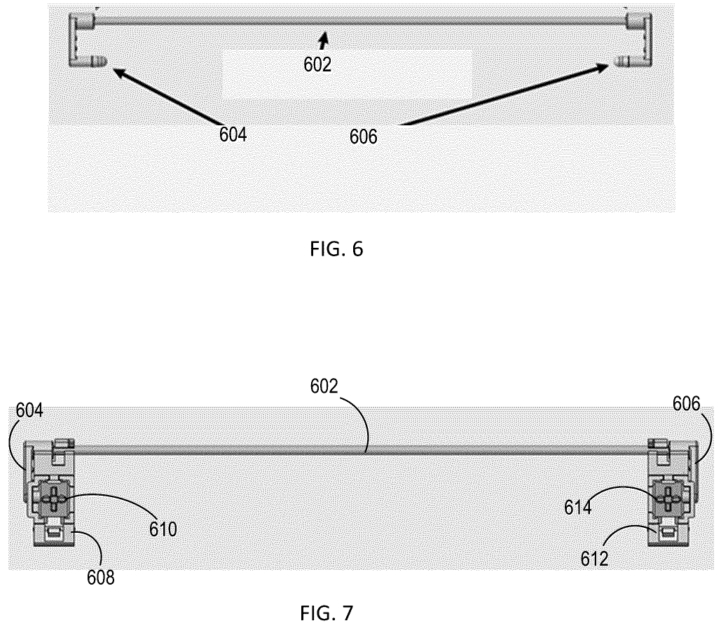

In certain embodiments, an improved stabilizer module for a keyboard key is provided. The stabilizer module has an elongated balance bar 602 with end-pieces as shown in FIG. 6. First and second bases 608 are mounted to engage first and second ends of the elongated balance bar, each with a curved, mostly vertical slots. In the embodiment of FIGS. 6-7, the end-piece is U-shaped. First and second stems 610 (for attaching to a key) are mounted in first and second cavities in the first and second bases, respectively, for vertical movement within the first and second cavities. The stems have a horizontally extending slot.

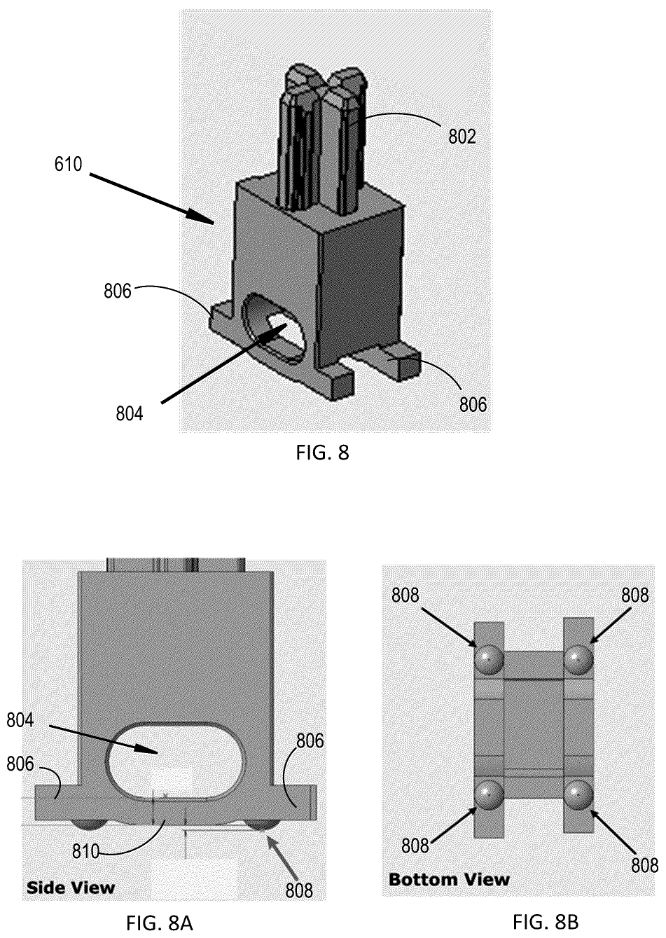

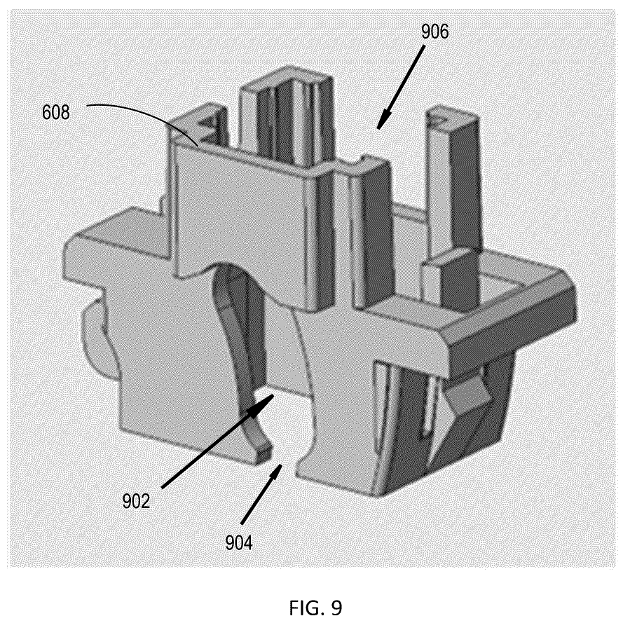

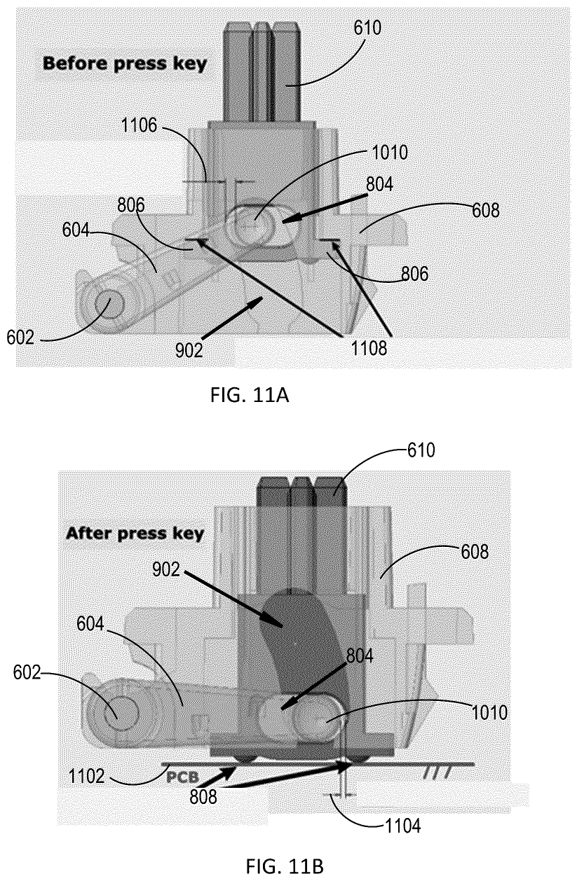

The stem with its horizontally extending slot is shown in FIGS. 8-8B. The base with its curved slot is shown in FIG. 9. FIGS. 11A-B are diagrams illustrating the rotation of the balance bar's U-shaped end-piece in the base and stem slots. Before a key press, stem 610 is high in the cavity of base 608. End-piece 604 has rotated around balance bar 602 so that an insertion arm 1010 is near the top of slot 902 in the base and near the left of slot 804 in stem 610. During a key press, the stem is pushed downward, causing the end-piece to rotate around the axis of the balance bar, and move downward. The downward movement tracks the curved base slot as the end-piece rotates, and the insertion arm of the end-piece moves side-to-side in the horizontal slot of the stem. This structure allows easy assembly and tight tolerances on the slots, giving a structure with little play and thus little noise.

The novel concepts (e.g., key structures) described herein are typically described and depicted for use in a computer keyboard, however these novel concepts can be applied to any input device that incorporates balance bar key structures, as would be appreciated by one of ordinary skill in the art with the benefit of this disclosure. In some cases, other materials can be used to further improve (reduce) noise characteristics of the key press including the addition of grease in the chambered track, or the use of a non-metal material for the balance bar or coating thereof for reduced friction and/or impact (e.g., rigid plastic, rubber/plastic sleeve on the balance bar, etc.).

It is to be understood that this high-level summary is presented to provide the reader with a baseline understanding of some of the novel aspects of the present disclosure and a roadmap to the details that follow. This high-level summary in no way limits the scope of the various embodiments described throughout the detailed description and each of the figures referenced above are further described below in greater detail and in their proper scope.

### Reduced Noise Stabilizer Module Design

FIG. 6 is a diagram of an improved balance bar structure with U-shaped end-pieces, according to certain embodiments. Balance bar 602 is a straight bar, made of metal in one embodiment. For example, the metal can be stainless steel. Two U-shaped end-pieces 604 and 606 are attached to balance bar 602. In one embodiment, the U-shaped end-pieces 604 are made of plastic and are press-fitted or molded (e.g., insert molding) onto the ends of metal balance bar 602. In one embodiment, the plastic is Polyoxymethylene (POM) or another thermoplastic.

FIG. 7 is a diagram of the balance bar structure of FIG. 6 inserted into a novel base and stem structure, according to certain embodiments. End-piece 604 is inserted into base 608 and stem 610. End-piece 606 is inserted into base 612 and stem 614. With the U-shape, the end-pieces enter the base and stem from the sides, not from in front as in the prior art structure. This provides assembly and noise reduction advantages, in combination with the unique shape of the base and stem, as described below.

FIGS. 8-8B are diagrams of the stem structure, according to certain embodiments. FIG. 8 shows a stem 610 that has a cross-shaped element 802 at the top for engaging a corresponding recess in the bottom of a space bar or other key. A horizontal slot 804 accepts the end of the balance bar's U-shaped arm. The slot can be on just the side of the U-shaped arm, or both sides of the stem for symmetry and ease of manufacture and assembly. Feet 806 provide small areas for a stop when the stem rises upon release of the space bar, as will be described in more detail below. In one embodiment, the stem is plastic, such as Polyoxymethylene (POM) or another thermoplastic.

FIGS. 8A-8B are side and bottom views of the stem structure of FIG. 8. These figures show bottom bumps 808 on the bottom of the stem 610. These bumps provide stops against the PCB or other substrate when the stem moves downward in response to pressing of the space bar. The reduced surface area of the bumps reduces the amount of sound made when the PCB is contacted.

FIG. 8A shows a bottom wall 810 of slot 804. The design is a trade-off between a desire to have the slot low in the stem, and at the same time provide the bottom wall with sufficient thickness to maintain the needed strength. In one embodiment, bottom wall 810 has a thickness of less than 1 mm. This includes a portion that is lower than the bottom of feet 806, but also above the bottom of bumps 808 so that wall 810 does not contact the PCB when the stem is depressed.

FIG. 9 is a diagram of a base structure, according to certain embodiments. Base 608 has a mostly vertical, curved slot 902 for accepting the end of the U-shaped end-piece of the balance bar. The slot 902 is narrower at a bottom portion 904 to keep the end-piece from slipping out. In alternate embodiments, the slot can be closed with a bottom wall. Slot 902 is at an angle of about 80 degrees near the bottom, bending to an angle of approximately 70 degrees near the top of slot 902. Alternately, the angles can vary within the range of 60-90 degrees. A central cavity 906 in base 608 accepts stem 610, which slides up and down within cavity 906. In one embodiment, the base is plastic, such as Polyoxymethylene (POM) or another thermoplastic.

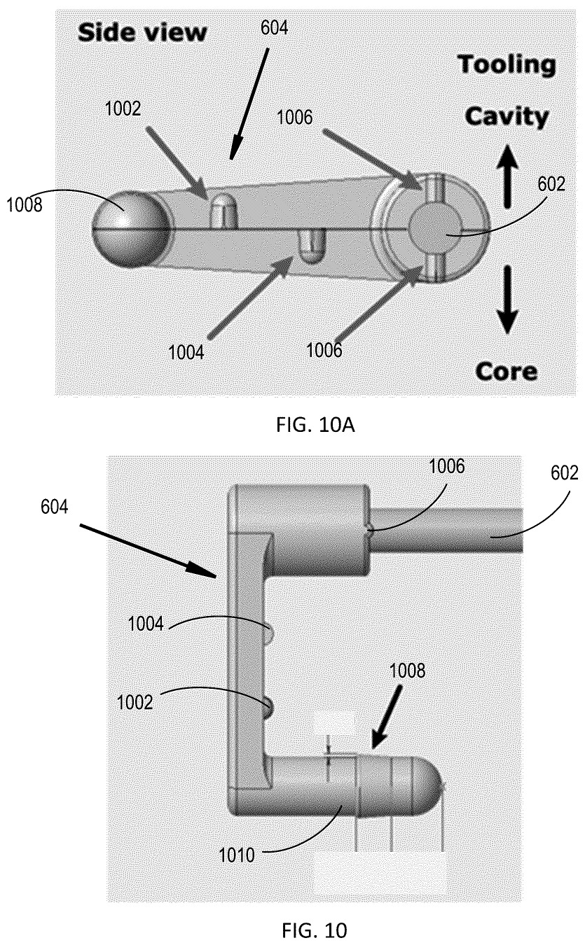

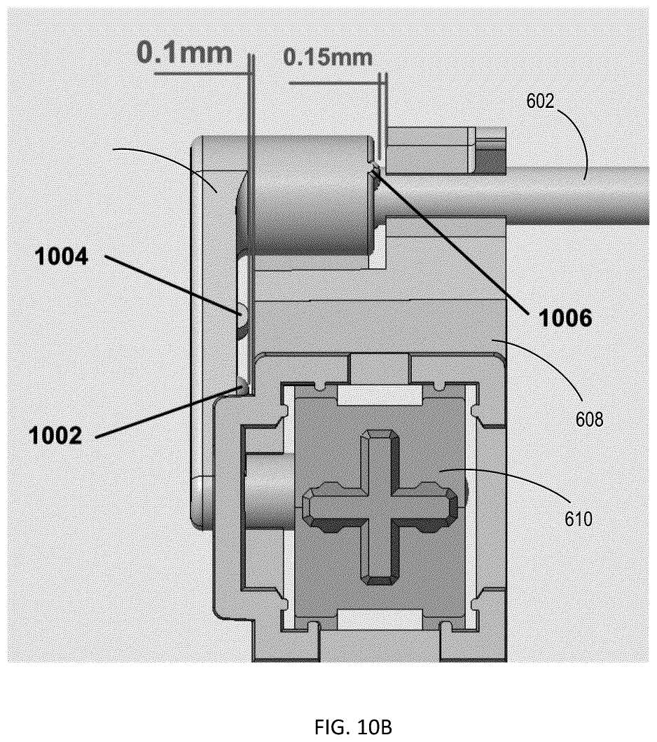

FIGS. 10 and 10A are diagrams of details of the balance bar's U-shaped end-pieces, according to certain embodiments. As shown in FIG. 10, U-shaped end-piece 604 is a plastic part pressed fitted or molded onto the end of metal balance bar 602. End-piece 604 has a pair of bumps 1002 and 1004. Bumps 1002 and 1004 act as smaller contact points with base 608 during rotational movement of end-piece 604. In one embodiment, the bumps are between 0.2-0.4 mm in height. An insertion arm 1010 of the end-piece fits into the slots in base 608 and stem 610. A bump 1008 on insertion arm 1010 is slightly wider to secure insertion arm 1010 in the slots after insertion. Bump 1008 increases slightly from right to left in FIG. 10. A ridge 1006 is formed on the portion of end-piece 604 that connects with balance bar 602. Ridge 1006 functions to provide a smaller contact point to reduce friction with base 608 during rotation. As can be seen in FIG. 10B, when the end piece 604 is inserted into base 608, there are potential contact or rubbing points due to potential variances in assembly and movement tolerances, so that there could be a shift or deformation from the designed small gap. Bumps 1002, 1004 and 1006 insure separation of the main body of end piece 604 from base 608. The design provides a small gap, as shown, but if there is contact, it will just be with the bumps, reducing friction and resistance to movement. Alternately, other designs could be used, such as a single bump in place of bumps 1002 and 1004. Also, ridge 1006 could be circular, circumscribing balance bar 602

FIG. 10A is a side view of end-piece 604, looking from right to left in FIG. 10. End-piece 604 is narrower near insertion arm 1010, since insertion arm 1010 is sized small enough to fit within the stem, while being large enough to have sufficient strength. The right side of insertion arm 1010 is larger because it needs to wrap around balance bar 602 with enough thickness to ensure sufficient strength during operation of the stabilizer structure.

FIGS. 11A-B are diagrams illustrating the rotation of the balance bar's U-shaped end-piece in the base and stem slots, according to certain embodiment. FIG. 11A shows the structure before a key press, and FIG. 11B shows the structure after a key press. As can be seen in FIG. 11A, stem 610 is high in the cavity of base 608. End-piece 604 has rotated around the axis of balance bar 602 so that insertion arm 1010 is near the top of slot 902 in the base and near the left of slot 804 in stem 610. The design of the structure, with insertion arm 1010 inserted through the slots straight in (horizontally, not tilted), allows tight tolerances for the slots. The slots then do not have a lot of play which would cause noise. In addition, a small margin is provided at the edges of slot 804 in the stem, as indicated by arrows 1106. In one embodiment, the small margin is 0.2-0.6 mm. This ensures that the insertion arm 1010 will not hit the ends of the slot 804, thus avoiding noise due to such contact. The tops of feet 806 of stem 610 contact stops 1108 of the base 608. This prevents further vertical movement upward of the stem, which in turn stops the lateral movement of insertion arm 1010 as end-piece 604 rotates.

FIG. 11B illustrates the base and stem structure after a key press, while the key is depressed. U-shaped end-piece 604 has rotated downward so that it is basically horizontal. During the downward rotation, insertion arm 1010 moves from left to right in slot 804 of stem 610. At the same time, insertion arm 1010 moves downward and to the right in slot 902 of base 608, following the curved path of slot 902. Upon reaching the bottom of slot 902, insertion arm 1010 stops just short of hitting the bottom of the slot since the bumps 808 on the bottom of stem 610 contact PCB 1102, preventing further movement. Bumps 808 limit the surface area in contact with PCB 1102, thus limiting the amount of noise created when the stem bumps come in contact with the PCB. There is also a gap between the insertion arm 1010 and the right side of slot 804, as indicated by arrows 1104. This gap, like the gap on the other side described above, prevents insertion arm 1010 from hitting the right side of slot 804 and creating a noise. In one embodiment, the gap is 0.2-0.6 mm.

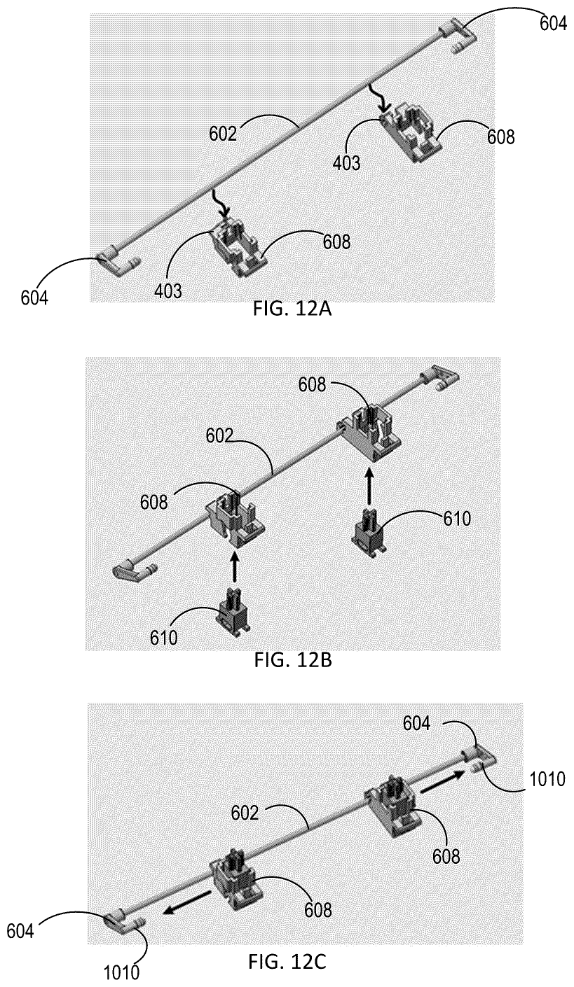

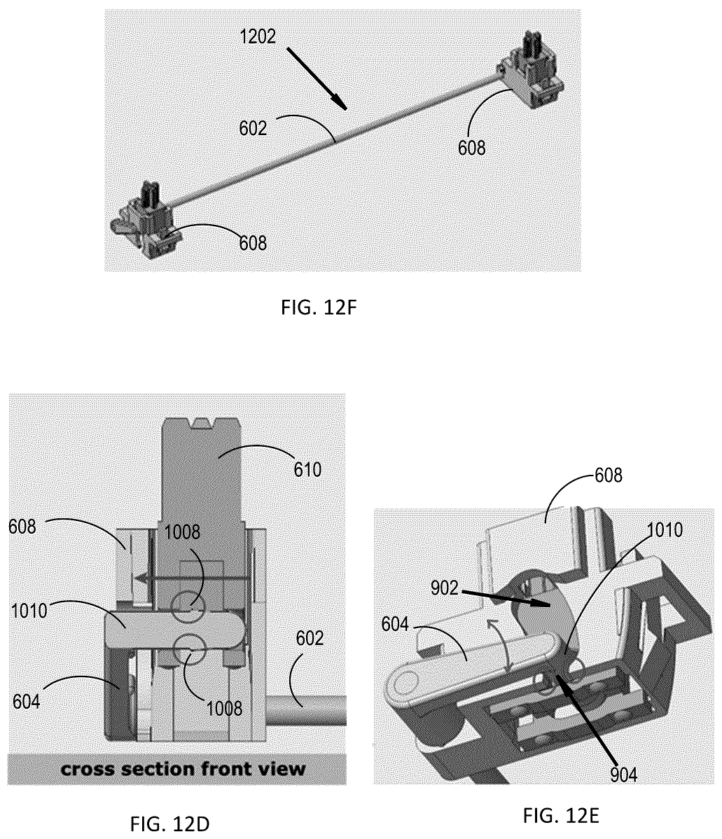

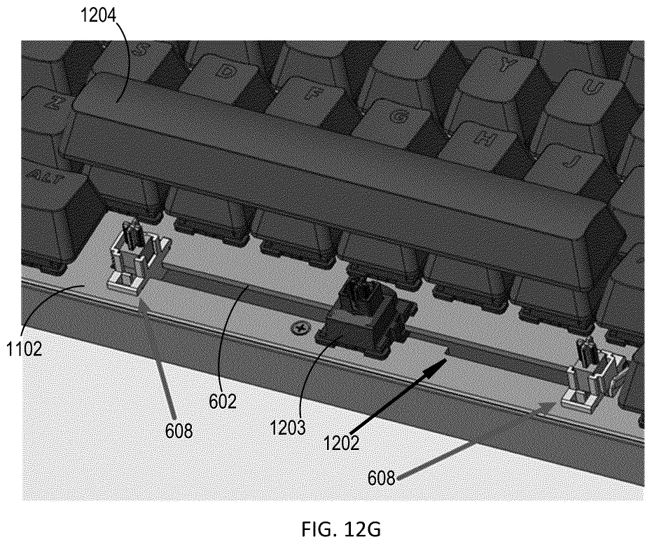

FIGS. 12A-G are diagrams illustrating the assembly of the stabilizer module's balance bar, base and stem, according to an embodiment. The plastic end-pieces 604 are molded over the balance bar 602. As shown in FIG. 12A, the balance bar 602 is then inserted into retaining slots 403 in base structures 608. Next, as shown in FIG. 12B, the stems 610 are inserted into the cavities of the base structures 608. As shown in FIG. 12C, the base structures 608 with the inserted stems are slid laterally to the edges (toward the ends) of balance bar 602 until insertion arms 1010 of end-pieces 604 snap into the slots of the base and stem structures, as described in earlier figures. As shown in FIG. 12D, insertion arm 1010 has a bump 1008 for holding insertion arm 1010 in the slots of the base and stem. In one embodiment, bump 1008 is between 0.05-0.2 mm in height. This bump avoids easily pulling/poping out for the module during movement, ensuring the assembly reliability.

As shown in FIG. 12E (and described earlier with respect to FIG. 9), the narrow bottom portion 904 of slot 902 in base 906 prevents arms 1010 from slipping out of the bottom of slots 902 during assembly.

FIG. 12F illustrates the completed stability module 1202 with the balance bar 602 connected to the bases 608.

FIG. 12G illustrates the completed stability module being mounted on a keyboard with a space bar structure. The stability module 1202 (with the balance bar 602 connected to the bases 608) is mounted on PCB 1102. A key switch 1203 is then mounted over the center of the balance bar of the stability assembly. Finally, a space bar 1204 is mounted over the stability module and key switch, with interior portions of the space bar engaging and snapping onto the stems 610.

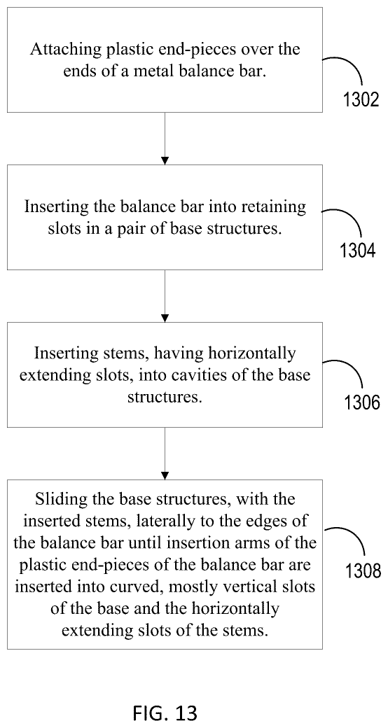

FIG. 13 is a flowchart of a method for assembling a stabilizer module for a keyboard key, according to certain embodiments. In step 1302, plastic end-pieces are attached over the ends of a metal balance bar. In step 1304, the balance bar is inserted into retaining slots in a pair of base structures. In step 1306, stems, having horizontally extending slots, are inserted into cavities of the base structures. In step 1308, the base structures, with the inserted stems, are slid laterally to the edges of the balance bar until insertion arms of the plastic end-pieces of the balance bar are inserted into curved, mostly vertical slots of the base and the horizontally extending slots of the stems.

### Performance Characteristics of Key Structures Utilizing the Novel Slider Structure

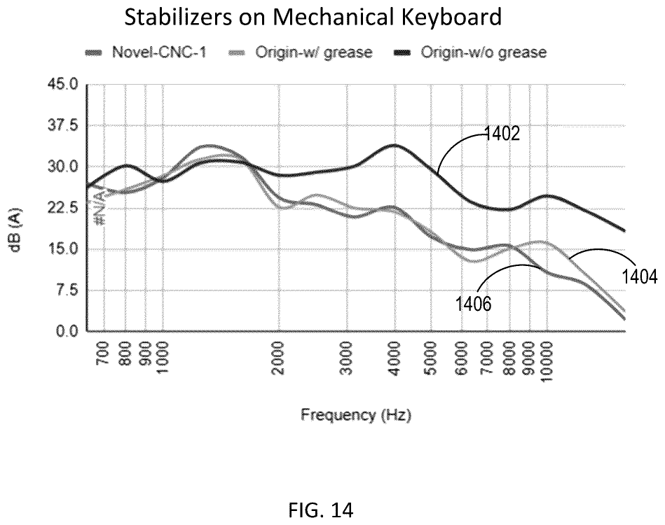

FIG. 14 is a graph showing noise distribution of a key press for a conventional space bar key with and without grease, and a novel space bar key using the stabilizer module of the invention. The stabilizer module as shown herein can significantly attenuate key click noise typically associated with keys that utilize a balance bar structure (e.g., space bar, tab, caps lock, shift, backspace, enter, etc.). In particular, the higher frequencies (e.g., 5 kHz-10 kHz) can be attenuated the most, which is typically the most noticeable to users (as opposed to lower frequencies, such as 0<5 kHz) and often the most irritating and annoying. By attenuating the “clickiness” of a key, particularly in the higher audio band, users experience the key as significantly quieter and preferable over conventional key structures.

The vertical axis of the graph of FIG. 14 shows noise in dBs, and the horizontal axis shows the frequency of the noise in Hz. Line 1402 corresponds to noise characteristics of a typical space bar key of a typical computer keyboard over an audio spectrum including 0-10 kHz, which includes the typical, practical audible range for a human. The noise, as described above, is mostly attributed to the “click” sound associated to a key press in a keyboard. Line 1404 corresponds to noise characteristics of a conventional space bar with grease added, showing a decrease in noise at the higher frequencies. Line 1406 corresponds to noise characteristics of a space bar key using the novel stabilizer module of the embodiments described herein. Line 1406 shows that noise levels drop at higher frequencies, similar to the conventional space key bar with grease. This is achieved without the added complication, cost, and manufacturing quality variability of using grease.

### Keyboard Mounting Structure

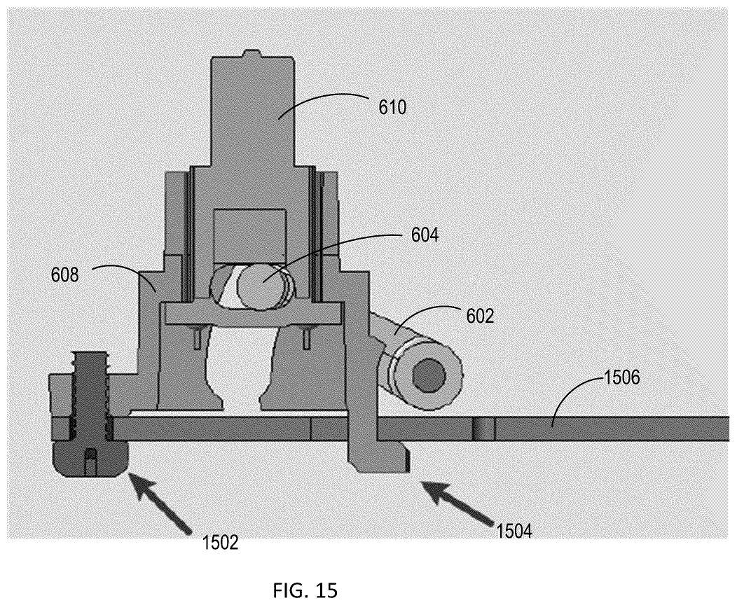

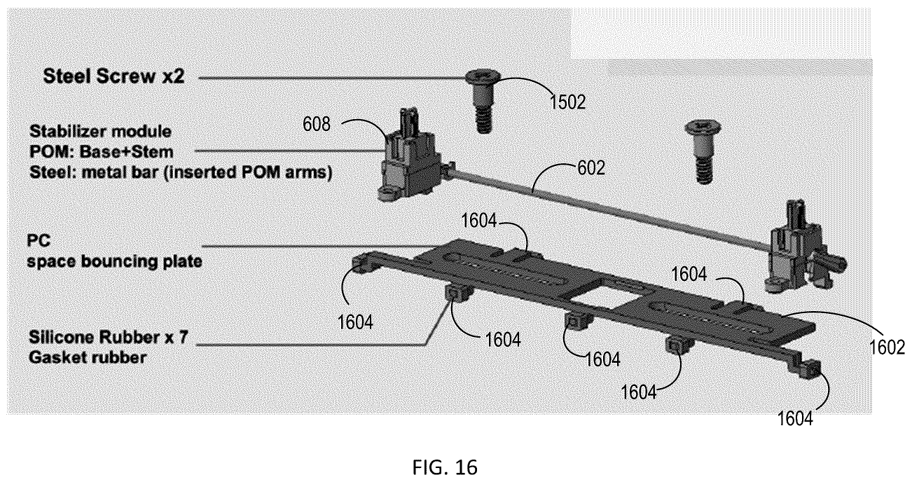

FIG. 15 is a diagram of a base structure for attaching to a PCB, according to certain embodiments. Shown is a base structure 608 with a stem 610 and the balance bar 602 with end-piece 604 extending through the slot in the base and stem, as described above. The base is mounted on a PCB 1506 using a screw 1502 and a hook 1504.

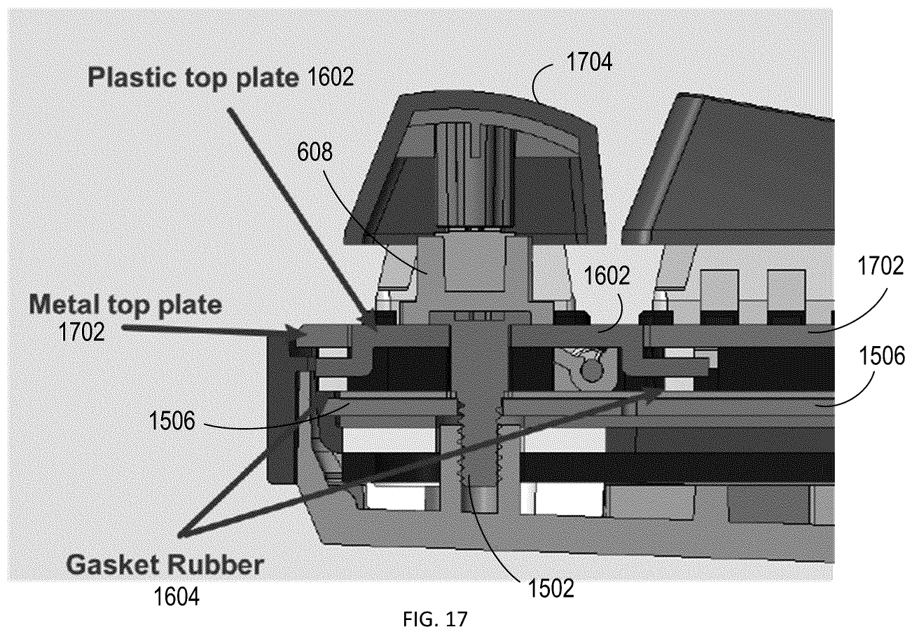

FIG. 16 is a diagram of a noise-reducing plastic insert for a metal top plate of a keyboard, according to certain embodiments. Plastic insert 1602 inserts into a metal top plate as will be shown in FIG. 17. The insert has more give than metal, thus producing less noise when a key is pressed against it. In addition, the plastic insert 1602 has a number of silicone rubber gaskets 1604 to attach it to the keyboard structure, providing additional flexibility and thus further reducing the noise produced. Also shown is the balance bar 602 and base 608, which are mounted adjacent the plastic insert 1602 and are fastened to the PCB below the plastic insert with screws 1502.

FIG. 17 is side, cutaway view of the insert of FIG. 16 in a keyboard structure, according to certain embodiments. As can be seen, plastic insert (top plate) 1602 is inserted into metal top plate 1702. Plastic insert 1602 is flush with metal top plate 1702, so that it does not add to the height and bulkiness of the structure. This allows a slim keyboard with a high-quality metal top case, while reducing the noise contribution normally present when a space bar is mounted on a metal top plate. Also shown are the attaching rubber gaskets 1604 of the plastic insert 1602. This view shows screw 1502 attaching the base structure 608 to PCB 1506. Above the base structure is a key 1704, which is a space bar in this embodiment.

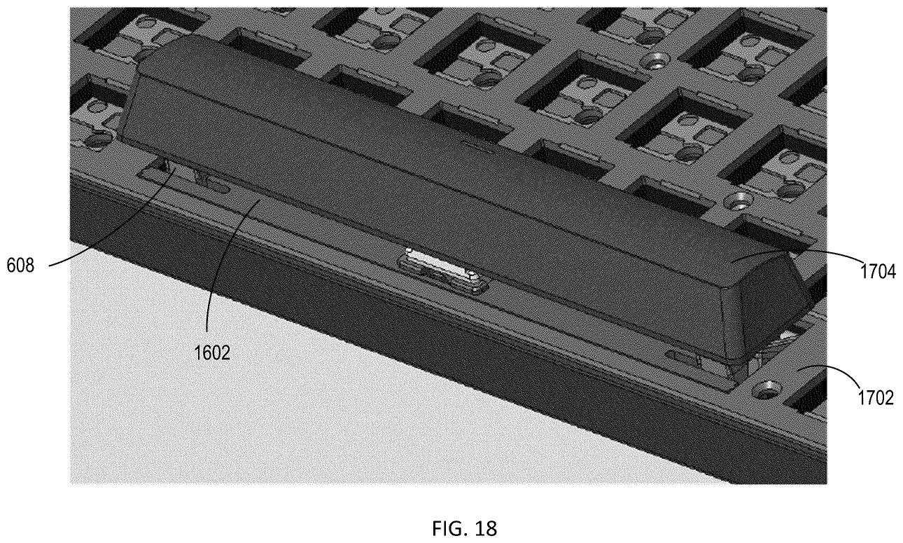

FIG. 18 is a perspective view of the plastic insert of FIG. 16 mounted below a space key, according to certain embodiments. The plastic insert 1602 can be seen under space bar 1704 which is lifted off to show the insert below. The base 608 is also partially visible. When the space bar is placed in position, attaching to the stems in the base structures, the plastic insert 1602 will be mostly not visible, thus it won't detract from the clean metal look of the metal top plate.

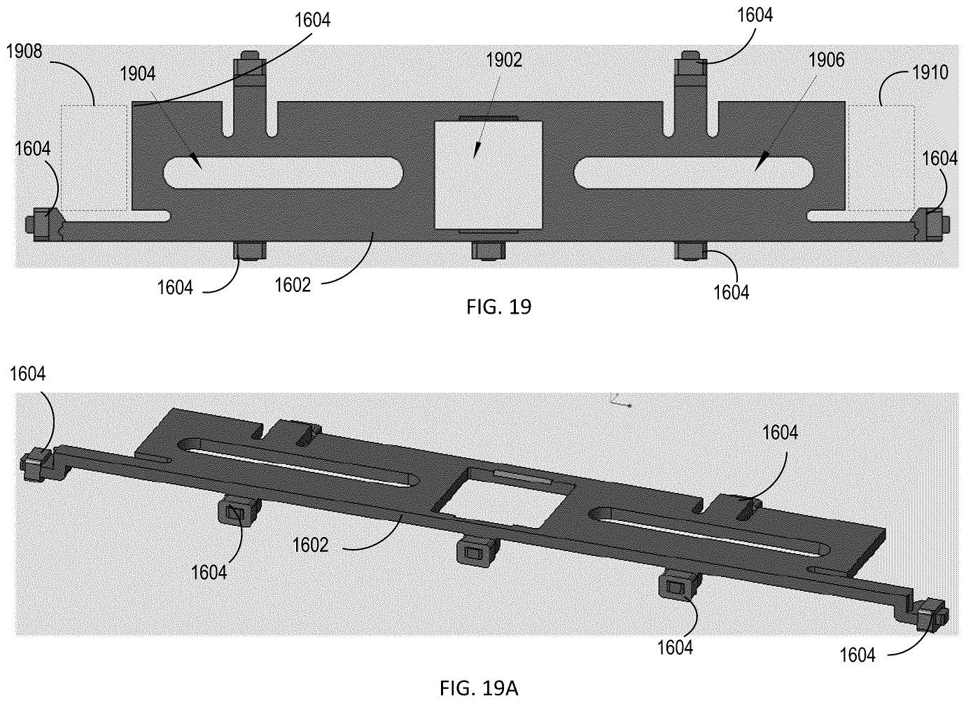

FIGS. 19 and 19A are top and perspective views of the plastic insert of FIG. 16, according to certain embodiments. The plastic insert 1602 with its rubber gaskets 1604 is shown. An opening 1904 accommodates the central keyswitch of a spacebar or other elongated key. Slots 1904 and 1906 provide openings to allow the plastic insert to bend even more around the axis of the slots, further reducing the noise. The base structures 608 are mounted at the positions indicated by dotted lines 1908 and 1910. The base structures are thus not mounted on the plastic insert. The central switch is mounted on the plastic insert. The space bar (keycap) bottom does not contact with the plastic insert. A timbre change mainly come from the main key switch mounting material & the plastic insert bouncing effect.

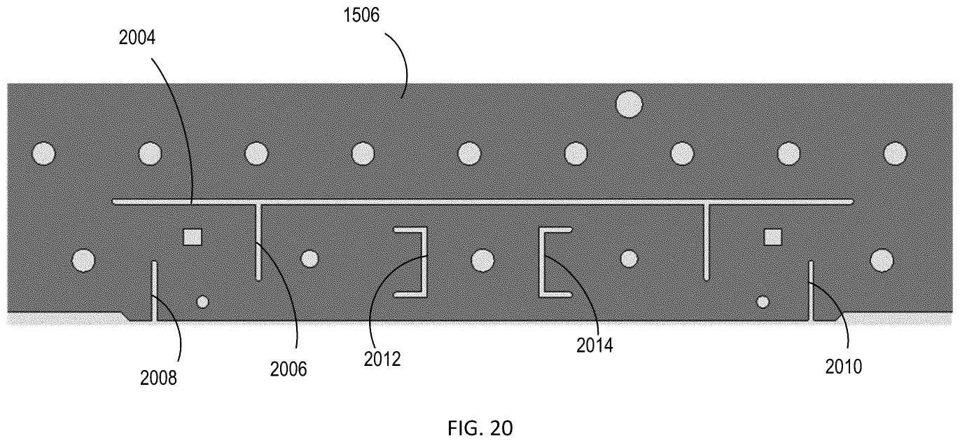

FIG. 20 is a diagram of a bouncing PCB, according to certain embodiments. PCB 1506 is designed to be somewhat bouncy in order to further reduce noise by allowing it to flex slightly when the space key over it is pressed. This is accomplished by adding a series of slots. Slot 2004 extends nearly the length of the PCB in the middle, and allows bending along the line of the slot, in line with slots 1904 and 1906 of plastic insert 1602. A number of perpendicular slots 2006, 2008, 2010, 2012 and 2014 provide flexibility in the other direction. The slots are narrow enough to avoid impairing the strength of the PCB, and are shaped to allow the needed electrical traces to be routed around the slots.

### Alternate Embodiments

The specific embodiments described herein can be varied while still being within the scope of the invention as set forth in the claims below. For example, the balance bar could be a hard plastic instead of metal, or a metal other than stainless steel. The end-pieces could be a different shape than the described U-shape, such as by having curves instead of right angles. Grease could be added to the arm of the end-piece to further reduce noise.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

What is claimed is:

1. A stabilizer module for a keyboard key comprising:
an elongated balance bar;
first and second bases mounted to engage first and second ends of the elongated balance bar with first and second curved, mostly vertical slots for engaging the first and second ends of the elongated balance bar; and
first and second stems mounted in first and second cavities in the first and second bases, respectively, for vertical movement within the first and second cavities, and having horizontally extending slots.

2. The stabilizer module of claim 1 wherein the first and second ends of the elongated balance bar are insertion arms of U-shaped end-pieces at the end of the elongated balance bar.

3. The stabilizer module of claim 2 wherein the elongated balance bar is metal and the U-shaped end-pieces are plastic.

4. The stabilizer module of claim 2 wherein the elongated balance bar is mounted in securing slots at a bottom of the first and second bases, such that the elongated balance bar rotates within the securing slots while the insertion arm moves vertically within the curved, mostly vertical slot as the stems are moved up and down.

5. The stabilizer module of claim 2 wherein the curved, mostly vertical slots are open at a bottom of the first and second bases, but is narrow at the bottom to keep the insertion arms of the elongated balance bar in the curved, mostly vertical slots.

6. The stabilizer module of claim 1 further comprising a plastic insert mounted below the keyboard key, flush with a metal top plate of the keyboard, with the first and second bases mounted on a printed circuit board below the plastic insert and metal top plate.

7. The stabilizer module of claim 1 wherein the first stem has a plurality of bumps on a bottom of the first stem, wherein the second stem has a plurality of bumps on a bottom of the second stem, wherein the plurality of bumps on the bottom of the first stem and the second stem reduce their contact area and thus reduce their noise as the stems descend and contact a substrate at the bottom of the bases.

8. The stabilizer module of claim 2 further comprising a bump on the insertion arm for retaining the insertion arm within the slots of the base and stem.

9. The stabilizer module of claim 1 further comprising top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases.

10. The stabilizer module of claim 1 wherein the first and second curved, mostly vertical slots in the bases are curved at varying angles, with the varying angles being no less than 60 degrees and no more than 90 degrees.

11. A stabilizer module for a keyboard key comprising:
an elongated balance bar;
first and second bases mounted to engage first and second ends of the elongated balance bar with first and second curved, mostly vertical slots for engaging the first and second ends of the elongated balance bar; and
first and second stems mounted in first and second cavities in the first and second bases, respectively, for vertical movement within the first and second cavities, and having horizontally extending slots;
top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases,
wherein the first and second ends of the elongated balance bar are insertion arms of U-shaped end-pieces at the end of the elongated balance bar,
wherein the elongated balance bar is metal and the U-shaped end-pieces are plastic, and
wherein the elongated balance bar is mounted in securing slots at a bottom of the first and second bases, such that the elongated balance bar rotates within the securing slots while the insertion arm moves vertically within the curved, mostly vertical slot as the stems are moved up and down.

12. The stabilizer module of claim 11 wherein the curved, mostly vertical slots are open at a bottom of the first and second bases, but is narrow at the bottom to keep the insertion arms of the elongated balance bar in the curved, mostly vertical slots.

13. The stabilizer module of claim 11 further comprising a pair of bumps on an interior of each of the U-shaped end-pieces at positions where the bumps contact a part of the first and second bases that reduces a contact area and thus reduces friction.

14. The stabilizer module of claim 11 further comprising a bump on the insertion arm for retaining the insertion arm within the slots of the base and stem.

15. The stabilizer module of claim 11 further comprising top and bottom stops on the stems positioned to contact portions of the base during vertical movement so that stop positions keep the first and second ends of the elongated balance bar from hitting the ends of the horizontally extending slots in the stems and the ends of the first and second curved, mostly vertical slots in the bases.

16. The stabilizer module of claim 1 wherein the first and second curved, mostly vertical slots in the bases are curved at varying angles, with the varying angles being no less than 60 degrees and no more than 90 degrees.

17. A method for assembling a stabilizer module for a keyboard key comprising:
attaching plastic end-pieces over ends of a metal balance bar, the ends including a first end and a second end;
inserting the balance bar into retaining slots in a pair of base structures;
inserting stems, having horizontally extending slots, into cavities of the base structures; and
sliding the base structures, with the inserted stems, laterally to the ends of the metal balance bar until insertion arms of the plastic end-pieces of the balance bar are inserted into curved, mostly vertical slots of the base and the horizontally extending slots of the stems.

18. The method of claim 17 wherein the first end and second end of the metal balance bar are insertion arms of U-shaped end-pieces at the end of the metal balance bar.

19. The method of claim 17 further comprising snapping each insertion arm into the slots past a bump on the insertion arm.

20. The method of claim 17 wherein the curved, mostly vertical slots in the bases are curved at varying angles, with the varying angles being no less than 60 degrees and no more than 90 degrees.
